(19) United States
(12) Patent Application Publication
(10) Pub. No.: US 2009/0241171 A1
(43) Pub. Date: Sep. 24, 2009

(54) WEARABLE COMPUTER SYSTEM AND METHOD CONTROLLING INFORMATION/SERVICE IN WEARABLE COMPUTER SYSTEM

(76) Inventors: John Sunwoo, Daejeon (KR); Yong-Ki Son, Daejeon (KR); Myoung-Hwan Oh, Daejeon (KR); Hyun-Tae Jeong, Daejeon (KR); Ji-Young Choi, Daejeon (KR); Ji-Eun Kim, Daejeon (KR); Hee-Joong Ahn, Chungcheongnam-do (KR); Jin-Ho Yoo, Daejeon (KR); Bae-Sun Kim, Daejeon (KR); Dong-Woo Lee, Daejeon (KR); Ga-Gue Kim, Daejeon (KR); Il-Yeon Cho, Daejeon (KR); Dong-Won Han, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/439,106

(22) PCT Filed: Aug. 29, 2007
(86) PCT No.: PCT/KR2007/004157

§ 371 Date: Feb. 26, 2009

(30) Foreign Application Priority Data
Aug. 30, 2006 (KR) 10-2006-0083051

(51) Int. Cl. G06F 15/16; G06F 21/00

(52) U.S. Cl. 726/3; 709/217

(57) ABSTRACT

A wearable system and a method for transferring and controlling information/service based on biologically generated information from a user are provided. In the method, an intuitive bio signal generated by a user is sensed and a device pointed by the sensed bio signal is selected. Then, bio signal information is created using the sensed bio signal and the generated bio signal information is transmitted to the selected device. After transmitting, the information/service is transferred to the selected device after confirming that the selected device that receives the bio signal information is activated.

### TECHNICAL FIELD

The present invention relates to a wearable computer system and a method for transferring and controlling information/service in the same and, more particularly, to a wearable system and a method for controlling information/service using biologically generated information while at least one of users transfer the information/service to peripheral devices or other users without having any spatial and circumferential limitations.

### BACKGROUND ART

A wearable system is a technology for enabling a user to use a computing system while the user is moving around. A wearable computer is one of representative wearable systems, which is worn on the body. The wearable computer has been advanced from a notebook computer type or a personal digital assistant (PDA) type to a module based wearable computer. The module based wearable computer includes a plurality of light and miniaturized modules disposed at the predetermined inside positions of a cloth. These modules are the next generation computer that maximizes the wearing sensation and the activity of the user in views of ergonomics and weight balancing. At the same time, the wearable computer provides an easy control mechanism to a user to minimize a self learning period in a view of usages convenience. Recently, the interesting of the external shape of the wearable computer has also increased.

A conventional wearable system was introduced in Korean Patent No. 1996-7003124 entitled “wearable personal computer system”. The conventional wearable system is a portable computer system constituted of a plurality of micro computing modules and at least one of flexible wearable frames. The conventional wearable system, however, only receives voice commands from a user to control. That is, the conventional wearable system has no other input device to receive different intuitive commands. Furthermore, the conventional wearable system has no function for interactive services among the wearable computers of at least two or more users.

Another related technology was disclosed at Korean Patent Application No. 10-2003-0035361 entitled “MULTIMODE DATA INPUT DEVICE AND METHOD THEREOF”. The multimode data input device has a structure to provide the mobility and the usage convenience to a user not limiting a user's activity. The multimode data input device can be applied to various application-level devices such as a computer, a PDA, a portable telephone, a tablet PC and a wearable computer. The multimode data input device, however, requires a user to hold a terminal with the hands, thereby degrading the mobility and the activity of the user. Also, the multimode data input device has no function for interactive services among the wearable computers of at least two or more users.

Recently, technologies for providing an interactive service among the devices of at least two or more users were introduced. For example, a system for direct data communication between wireless telecommunication devices was introduced in Korean Patent Application No. 10-2006-0006037. A mobile terminal with resource sharing service function, a resource sharing system thereof, and a method thereof were introduced in Korean Patent Application No. 10-2004-0072403, and a method for exchanging information and a system thereof were introduced in Korean Patent Application No. 10-2004-0073524.

Such conventional technologies require a user to use a mobile communication terminal. Although the conventional technologies allow users to easily carry and to directly share information with other devices, the conventional technologies fail to reach a function to provide data communication and to share resources based on user's intuitive motion or voice.

Therefore, there is a demand for a technology for transferring information/service to user devices such as a mobile communication terminal or to other users while guaranteeing the mobility and the activity of a user.

### DISCLOSURE OF INVENTION

### Technical Problem

An aspect of the present invention is to provide a wearable system controlled based on biologically generated information, such as intuitive motions and voices, and a method for controlling the system/service in the system.

Another aspect of the present invention is to provide a wearable system and method for transferring and controlling information/service with peripheral devices or other users without having spatial limitation.

### Technical Solution

According to an aspect of the invention, the invention provides a method for transferring information/service in a wearable system including: sensing an intuitive bio signal generated by a user; selecting a device pointed by the sensed bio signal; creating bio signal information using the sensed bio signal; transmitting the generated bio signal information to the selected device; and transferring the information/service to the selected device after confirming that the selected device that receives the bio signal information is activated.

The method may further include transferring the information/service according to an authentication result if the selected device is the other user's a wearable system.

According to another aspect of the invention, the invention provides a method for controlling information/service of a wearable system including: transferring information/service to a device selected by an intuitive bio signal generated by a user; controlling the transferred information/service by remotely controlling the selected device based on an instruction given by a user through the bio signal; and storing the controlling result after the control of the selected device ends.

The method may further include: sensing an intuitive bio signal of the user; selecting the other device pointed by the bio signal if the intuitive bio signal of the user points the other device; establishing a control channel to the selected device; and controlling the transferred information/service by remotely controlling the selected device based on an instruction given by the user through the bio signal.

According to yet another aspect of the invention, the invention provides a wearable system including: a signal sensing unit for sensing an intuitive bio signal of a user; a central processing unit for detecting the bio signal, selecting a device pointed by the detected bio signal, and generating bio signal information to transmit to the selected device; and a transmitting/receiving unit for transmitting the generated bio signal information, receiving related information from the selected device, and transferring information/service to the selected device.

The wearable system may further include: an authenticating unit for authenticating a wearable system of the other user when receiving information/service from the wearable system of the other user.

### ADVANTAGEOUS EFFECTS

A wearable computer system and a method for transferring and controlling information/service in the same according to the certain embodiment of the present invention guarantee a user to use the hands freely and maximize the activity and the convenience of the user. The wearable system can control other peripheral devices by sensing bio signal such as the intuitive motion or voice made by a user, generating the bio signal information based on the sensing result, and performing operations related to an instruction given by the user based on the generated bio signal information. Also, the wearable system can transfer and control information/service to other devices or other users without having temporal and spatial limitation, thereby allowing a plurality of users to use a predetermined service together.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a block diagram illustrating a wearable system according to an embodiment of the present invention;

FIG. 2 is a block diagram illustrating an environment for transferring and controlling information/services between a wearable computer and a peripheral device in a wearable system according to an embodiment of the present invention;

FIG. 3 is a block diagram illustrating an environment for transferring and controlling information/services between devices in a wearable system according to an embodiment of the present invention;

FIG. 4 is a block diagram illustrating an environment for transferring and controlling information/services between wearable computers in a wearable system according to an embodiment of the present invention;

FIG. 5 is a flowchart illustrating a method for transferring information/service in a wearable system according to an embodiment of the present invention; and

FIG. 6 is a flowchart illustrating a method for controlling information/service in a wearable system according to an embodiment of the present invention.

### BEST MODE FOR CARRYING OUT THE INVENTION

Hereinafter, preferred embodiments of the present invention will be described in detail with reference to the attached drawings. Like numeral references denote like elements throughout the accompanying drawings. In order to clear describe the present invention, the descriptions of well known functions and elements will be omitted.

A wearable system according to an embodiment of the present invention is a computing system having computation power. Since the wearable system according to the present embodiment is formed of a plurality of modules, the wearable system can be assembled and disassembled in various shapes according to a desired function and convenience. The disassembled modules can be communicated with each other through a wired link and/or a wireless link. Hereinafter, the structure of the wearable system according to the present embodiment will be described with reference accompanying drawings.

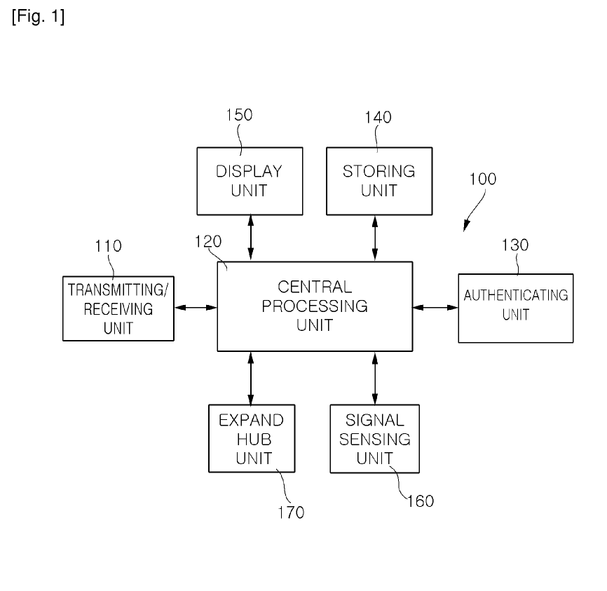

FIG. 1 is a block diagram illustrating a structure of a wearable system according to an embodiment of the present invention.

Referring to FIG. 1, the wearable system 100 according to the present embodiment is a module based computing system that can be worn on the body of a user. The wearable system 100 according to the present embodiment includes a transmitting/receiving unit 110, a central processing unit 120, an authentication unit 130, a storing unit 140, a display unit 150, a signal sensing unit 160, and a hub 170.

The transmitting/receiving unit 110 includes wireless communication module such as a wire/wireless LAN or IrDA. The transmitting/receiving unit 110 transmits and receives information/services to/from other users or other devices/systems.

The central processing unit 120 includes a main processor for performing the most of computation. The central processing unit 120 transfers and controls information/services in response to sensed biologically generated information as an instruction to control. Also, the central processing unit 120 controls information/services by remotely controls a peripheral device to control information/services. Accordingly, the user is enabled to perform operations related to information/service transferred to a peripheral device through the screen of the own display unit 150.

The authentication unit 130 performs authentication processes through a personal information management (PIM) or a near-field communication (NFC).

The storing unit 140 stores information related to a bio signal sensed by the sensing unit 160, data and information related to a service such as Internet browsing or multimedia streaming. The bio signal information includes all bio signals generated based on intuitive motion, voice, facial expression, body temperature, eye movement, and lip shape.

The display unit 150 provides information to a user, for example, through a predetermined display device such as a head-mounted display (HMD).

The signal sensing unit 160 senses the voice of a user through a microphone, or senses hand or arm motions made by a user through an accelerometer. The signal sensing unit 160 generates a bio signal by analyzing the sensing result.

Such modules of the wearable system according to the present embodiment are disposed to be worn on the body of a user, and the functions thereof are assembled together in consideration of ergonomic convenience, thereby freeing two hands of the user. For example, the wearable system according to the present embodiment can be embodied as a wrist band type wearable system. That is, a wrist band unit may be embodied to include the central processing unit 120, a signal transmitting/receiving unit 110, an authentication unit 130, and a signal sensing unit 160. The wrist band unit is worn on the wrist of a user for sensing a hand and arm motion made by the user. Also, the combination of the central processing unit 110, the storing unit 140, and the display unit 150 can be embodied as a cloth type wearable system. The cloth type wearable system interacts with the wrist band type wearable system. Therefore, a user can always carry around the wearable system and control the information/services without having spatial and environmental limitations.

The user can use various services or information through HMD without having the environmental limitation. Also, the wearable system 100 can be used as an input device when a user uses related services. In order to use such a wearable system as an input device, a user is required to give an instruction by generating a bio signal through making a predetermined motion or voice and control the service based on the generated bio signal. For example, when a user 10 wants to watch a movie through the HMD, a user displays icons on the screen of the HMD, clicks or moves the icons to select a desired movie, and watches the selected movie through making a predetermined hand/arm motion.

In such an environment, a user can control devices spatially separated from the user through a wireless link without having a spatial limitation. Herein, the user controls the device based on bio information generated trough making predetermined motions, gestures, or voices. That is, the wearable system senses the bio information made by a user and transfers the information to the desired device.

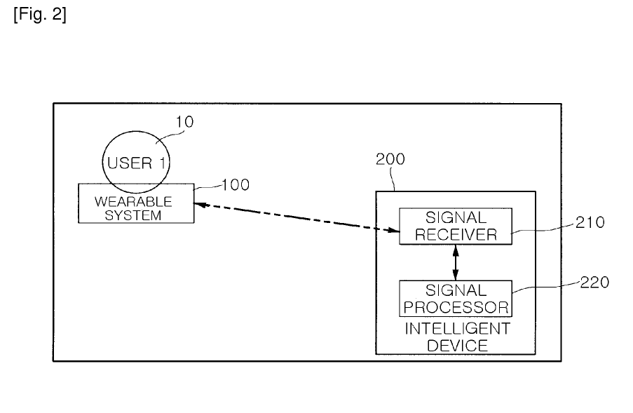

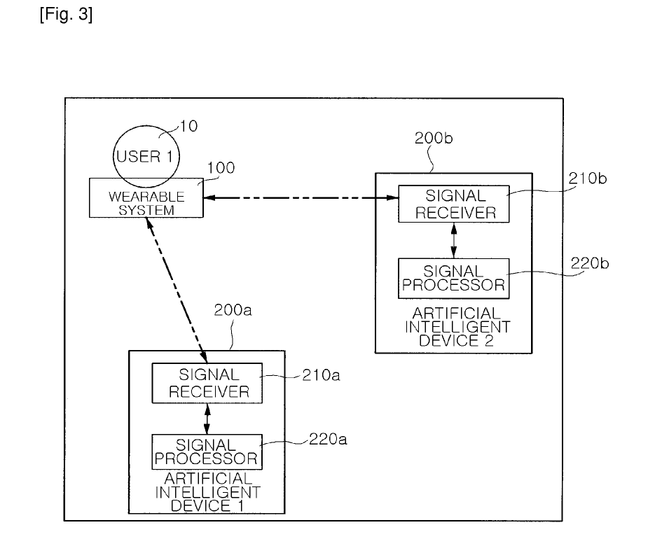

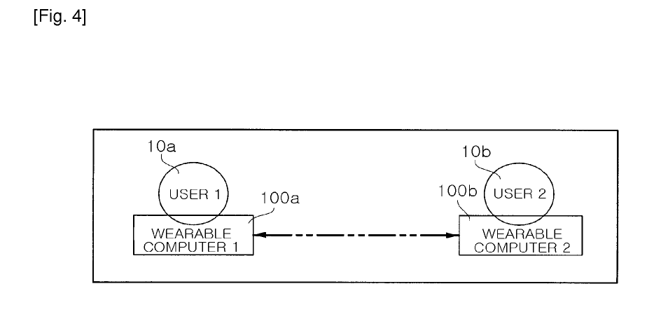

The wearable system according to the present embodiment allows a user to control other peripheral devices through communicating with other devices, systems, and users, remotely. FIG. 2, FIG. 3, and FIG. 4 show environments of a wireless communication between an artificial intelligent device and a wearable system, between the artificial intelligent devices, and between the wearable system and other user's wearable system. Herein, the peripheral devices and systems are an artificial intelligent device including multimedia functions, a signal receiving unit and a signal processing unit.

Referring to FIG. 2, a bio signal is sensed through an intuitive motion or voice made by a user 10, and bio signal information is generated for the instruction given from the user 10. The user 10 selects a desired device through the generated bio signal information. In FIG. 2, the device selected by the user 10 is the artificial intelligent (AI) device 200. The AI unit 200 senses the bio signal information received through the signal receiver 210, and performs operations in response to the instruction given from the user through analyzing the received bio signal information. Then, the wearable system 100 controls the AI unit 200 remotely in order to control the information/service.

Meanwhile, the wearable system transfers the information/services providing to a user to other peripheral devices, and enables the peripheral devices to use the transferred information/services. Therefore, a plurality of users can share the related service together.

A user can transfer a currently received service to a peripheral device. After the service is transferred to the peripheral AI unit from the wearable system, the wearable system transfers all controls to the selected device until the user withdraws the service from the selected device. For example, a user wants to watch a movie with a friend while the user is watching the movie, the user can transfer the movie to a selected peripheral device by making a predetermined hand/arm motion such as a motion pointing to a predetermined device such as television. Then, the selected television displays the movie transferred from the user's wearable system. FIG. 3 shows a system configuration for transferring information/service to other devices.

When a user 10 terminates a service being used in one AI unit 200a, the wearable system 100 enables a user 10 to continuously receive the terminated service by performing a predetermined storing operation or transferring the terminated service to another AI unit 200b that does not have any temporal and spatial limitations.

For example, when a user wants move to other location while watching the predetermined movie, the user stops the movie, selects a device, and displays the movie by pointing the selected device. Then, the selected device reproduces the movie from a part stopped at the previous device. Herein, the user may be allowed to change volume or screen setting regardless of the types of the devices.

Also, the information/services can be transferred between the wearable systems. Such a transferring operation is shown in FIG. 4.

Referring to FIG. 4, when a user 10a wants to transfer information/service to other users 10b, the wearable system 100a of the user 10a senses the motion or voice made by the user 10, and generates the sensed bio signal information. The opponent user 10b senses the generated bio signal information and receive the information/service transferred from the user 10a through the own wearable system 100b. Also, the wearable system 100b may ask the user 10b whether to accept the transferred information/service for security reason through a HMD screen or other output device. If the user 10b accepts the request, the wearable system 100b receives the information/service.

Hereinafter, a method for transferring and controlling information/service to peripheral devices/systems in a wearable system according to an embodiment of the present invention will be descried with reference to accompanying drawings.

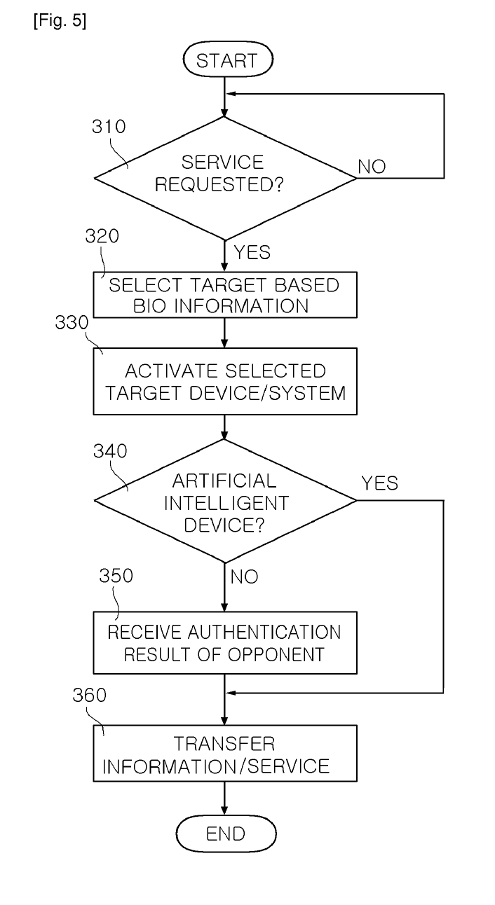

FIG. 5 is a flowchart illustrating a method for transferring information/services in a wearable system according to an embodiment of the present invention.

Referring to FIG. 5, a user may want to transfer information/services from one device to the other devices, or a wearable system to a peripheral device. Or, a user may receive a request to transfer a predetermined information/service to other device. The peripheral devices may be an artificial intelligent device or a wearable system of other user.

At step S310, a wearable system determines whether or not a user requests transferring information/service through making a predetermined intuitive motion and voice. Herein, the user may receive the request of transferring information/service from other users. In this case, the wearable system determines whether the request signal is received from the other user or not because the other user transmits the request signal through own wearable system.

If the information/service is requested to transfer at step S320, the wearable system senses a bio signal such as an intuitive motion of pointing a predetermined device or intuitive voice made by a user and generates bio signal information based on the sensing result. Then, the wearable system transfers the generated bio signal information to a device pointed by the user. That is, the user selects a target device through the bio signal information.

At step S330, the wearable system activates the selected device or the wearable system of other user, remotely. In order to activate the selected device, at first, a transmitting side wearable system recognizes bio signal information created in response to the intuitive motion of pointing a predetermined device or a predetermined voice, made by a user. Secondly, the signal transmitter of the transmitting side wearable system informs the predetermined device, which is pointed by the user or corresponding to the voice made by the user, of the necessity of the information/service transfer.

At step S340, the wearable system determines whether the receiving side is an artificial intelligent device or not. If the receiving side is the AI device, a step S360 is performed without performing an authentication step.

If the receiving side is another wearable system of other user, not the AI device, the wearable system waits for another wearable system to perform the authentication process and receives the authentication result at step S350 because another wearable system of the other user may be set to accept the information/service to be transferred after authenticating. Then, at step S360, the wearable system of the user confirms the received authentication result and transfers the information/service to another wearable system of the other user.

As described above, the user should easily control the transferred information/service. Hereinafter, a method for controlling information/service transferred in a wearable system according to an embodiment of the present invention will be described.

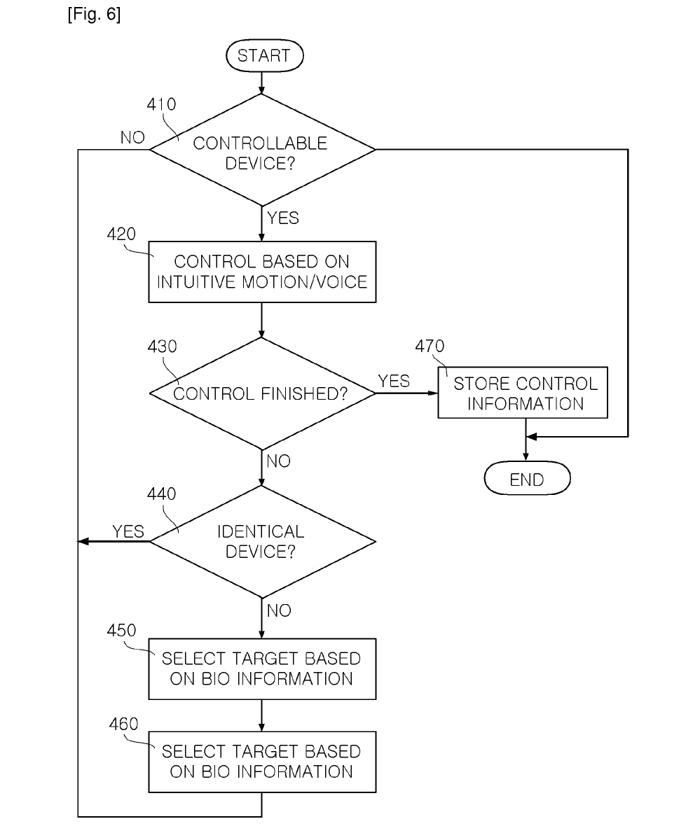

FIG. 6 is a flowchart illustrating a method for controlling information/service transferred to peripheral artificial intelligent devices in a wearable system according to an embodiment of the present invention.

Referring to FIG. 6, a wearable system determines whether a target object is controllable or not at step S401. If the target object is not controllable, the control operation is terminated.

At step S420, the wearable system senses a bio signal generated by an intuitive pointing motion or a predetermined voice made by the user in order to control the information/service of a target device, and generates the bio signal information based on the sensing result. Then, the wearable system remotely controls the other device by transferring the generated bio signal information to the target device.

The communication channel between the user's wearable system and the peripheral device, which is established when the information/service is initially transferred, is continuously activated until the user points another device or wants to interrupt the current communication channel.

Therefore, the wearable system determines whether the control ends or not at step S430. If the control does not end, a step S440 is performed. If the control ends, the step S470 is performed, the controlling result is stored, and the related operation is terminated.

Meanwhile, when the user points the other device through generating the bio signal, the communication channel to the current AU device is interrupted, and the information/service is required to transmit to the newly pointed other device. Therefore, at step S440, the wearable system determines whether the user pointed device is the previous device to transfer the information/service or not at step s440. If they are identical, the step S420 is performed.

On the contrary, at step S450, when they are not identical, the wearable system selects the pointed device, that is, the target device, and generates the bio signal information to the selected device. Then, the selected device receives the generated bio signal information, is activated, and transmits a response signal to the wearable system.

At step S460, the wearable system establishes a control channel to the newly selected device in order to transmit and receive information for remotely controlling the selected device. Then, the operations after the step S420 are repeatedly performed. The wearable system remotely controls the other device according to the user's bio signal through the established control channel. Herein, the wearable system transfers the information/service to the other device, and controls the transferred information/service according to the user's bio signal based on the method shown in FIG. 5.

According to needs, the wearable system according to the present embodiment can control the information/service of other wearable system by applying the method shown in FIG. 6.

Although the preferred embodiments of the present invention have been disclosed for illustrative purpose, those skilled in the art will appreciate that various modifications, additions and substitutions can be made without departing from the scope and spirit of the invention as defined in the accompanying claims.

1. A method for transferring information/service in a wearable system comprising:
sensing an intuitive bio signal generated by a user;
selecting a device pointed by the sensed bio signal;
creating bio signal information using the sensed bio signal;
transmitting the generated bio signal information to the selected device; and
transferring the information/service to the selected device after confirming that the selected device that receives the bio signal information is activated.

2. The method according to claim 1, further comprising transferring the information/service according to an authentication result if the selected device is the other user's wearable system.

3. A method for controlling information/service of a wearable system comprising:
transferring information/service to a device selected by an intuitive bio signal generated by a user;
controlling the transferred information/service by remotely controlling the selected device based on an instruction given by a user through the bio signal; and
storing the controlling result after the control of the selected device ends.

4. The method according to claim 3, further comprising:
sensing the intuitive bio signal of the user;
selecting the other device pointed by the bio signal if the user points the other device through the intuitive bio signal;
establishing a control channel to the selected device; and
controlling the transferred information/service by remotely controlling the selected other device based on an instruction given by the user through the bio signal.

5. The method according to claim 3, wherein the step of transferring the information/service to the selected device includes:
sensing an intuitive bio signal of the user;
selecting a device pointed by the sensed bio signal;
generating bio signal information to the selected device; and
transferring the information/service to the device after confirming that the device receiving the bio signal information is activated.

6. The method according to claim 5, further comprising:
receiving a result of authenticating the other user if the selected device is a wearable system of the other user; and
transferring the information/service to the wearable system of the other user if the other user is successfully authenticated.

7. A wearable system comprising:
a signal sensing unit for sensing an intuitive bio signal of a user;
a central processing unit for detecting the bio signal, selecting a device pointed by the detected bio signal, and generating bio signal information to transmit to the selected device; and
a transmitting/receiving unit for transmitting the generated bio signal information, receiving related information from the selected device, and transferring information/service to the selected device.

8. The wearable system according to claim 7, further comprising:
an authenticating unit for authenticating a wearable system of the other user when receiving information/service from the wearable system of the other user.

9. The wearable system according to claim 8, wherein the authentication unit is formed in a wrist band shape with the signal sensing unit, the central processing unit, and the transmitting/receiving unit, and worn on the body of the user.

10. The wearable system according to claim 8, further comprising:
a display unit for displaying the information/service; and
a storing unit for storing information related to the information/service and the bio signal information.

11. The wearable system according to claim 10, wherein the display unit and the storing unit are worn on the user as a cloth with the central processing unit combined together, and are separate from the signal sensing unit and the transmitting/receiving unit separated.

12. The wearable system according to claim 7, wherein the central processing unit controls the transferred information/service by remotely controlling the selected device based on an instruction given by the user through the bio signal.

13. The wearable system according to claim 7, wherein when the user points another device through the bio signal, the central processing unit establishes a control channel to the pointed device, transfers the information/service to the pointed device, and controls the transferred information/service through remotely controlling the pointed device.

14. The wearable system according to claim 13, wherein the central processing unit includes a function of controlling the information/service to transfer to the wearable system of the other user if the pointed device is the wearable system of the other user.
